(19) United States
(12) Patent Application Publication
(10) Pub. No.: US 2008/0192913 A1
(43) Pub. Date: Aug. 14, 2008

(54) USING NON-INTRUSIVE HOOKS TO PROVIDE COMBINATIONAL TELECOMMUNICATION SERVICES

(76) Inventors: B. Gopinath, Topanga, CA (US); Atul Gupta, Los Angeles, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/031,581

(22) Filed: Feb. 14, 2008

Related U.S. Application Data
(60) Provisional application No. 60/889,862, filed on Feb. 14, 2007.

(51) Int. Cl. H04M 3/42

(52) U.S. Cl. 379/207.04

(57) ABSTRACT

A SS7/PSTN network is monitored with non-intrusive hooks. Upon detecting or monitoring a signal event, combinational services are provided using one or more other communication channels.

### CROSS-REFERENCE TO RELATED APPLICATION

This application claims priority of provisional application 60/889,862, filed Feb. 14, 2007.

### BACKGROUND OF THE INVENTION

1. Field of the Invention

This invention relates to non-intrusive network monitoring. In particular, the present invention relates to providing combinational telecommunication services to users or groups of users based on signal events detected by a non-intrusive monitor.

2. Background

Current automated combinational services require tightly integrated solutions. These include current Operational Support Systems, (OSS) and Business Support Systems (BSS). They are capable of providing automated billing and other similar services.

U.S. Pat. No. 6,668,167 discloses a method and apparatus for sharing mobile user event information between wireless networks and fixed IP networks. In particular, it discloses a method for sniffing a signal passing between a base station controller (BSC) and a mobile switching center (MSC) of the wireless telephone network that indicates both the presence of the specific wireless device and the location of the specific wireless device, then broadcasting those signals over separate networks. In particular, the patent describes how this method may be used to send Instant Messages (IMs) between mobile devices and devices connected to fixed IP networks, such as computers connected to the Internet.

### SUMMARY OF THE INVENTION

The present invention provides a non-intrusive method for sniffing between any nodes in a SS7/PSTN network, not just BSC and MSC. Upon detecting or monitoring a signal event, combinational services are provided using one or more other communication channels. These channels are associated with a user, group, enterprise or operator. The process of placing non-intrusive hooks into a network in order to provide combinational services enables a large variety of automated telecommunication services without disrupting the current telecommunication infrastructure.

### BRIEF DESCRIPTION OF THE DRAWINGS

FIG. 1 illustrates a combinational service process in accordance with the present invention.

FIG. 2 illustrates a stateless combinational service for an individual.

FIG. 3 illustrates a stateless combinational service for a group.

FIG. 4 illustrates a session combinational service for an individual.

FIG. 5 illustrates a session combinational service for a group.

FIG. 6 is a network diagram showing a PSTN and Mobile network with a set of non-intrusive hooks.

FIG. 7 summarizes various embodiments of the invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

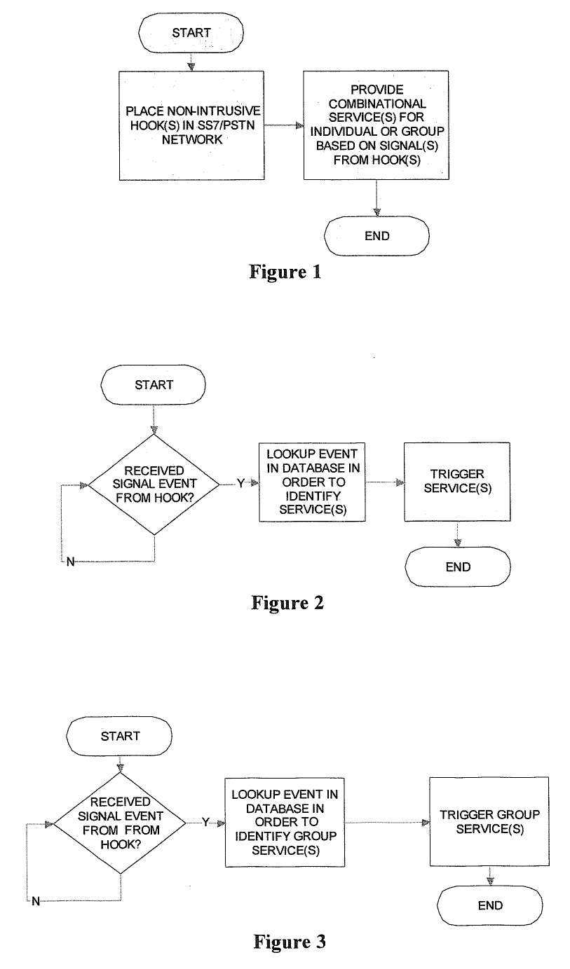

As illustrated generally in FIG. 1, the present invention relates to a set of processes for providing combinational services by using a set of non-intrusive signal hooks, which either detect a signal event or monitor a series of signal events over a session, over one or more channels, then provide one or more services over one or more channels. The channel(s) used for detection and the channel(s) used to provide the service may be different.

The combinational service may be provided in a stateless manner or may be provided as part of a session. In both cases, the service may be provided to an individual or to a group. This group may be physical group like an enterprise or may be a virtual group. The particular ways of providing combinational services are described below.

### Stateless Combinational Service for an Individual

FIG. 2 illustrates a general process of placing non-intrusive hook(s) into the SS7/PSTN network that are able to sniff the traffic, such that when the hook(s) detect a signal event, they first look up the signal event in a database in order to identify the corresponding service(s), and then trigger the combinational service(s).

### Stateless Combinational Service for a Group

In this case, illustrated in FIG. 3, the combinational service is provided to a group instead of an individual. When the signal event is detected, the system looks up the corresponding group service(s), and then the system triggers the group service(s).

### Session Combinational Service for Individual

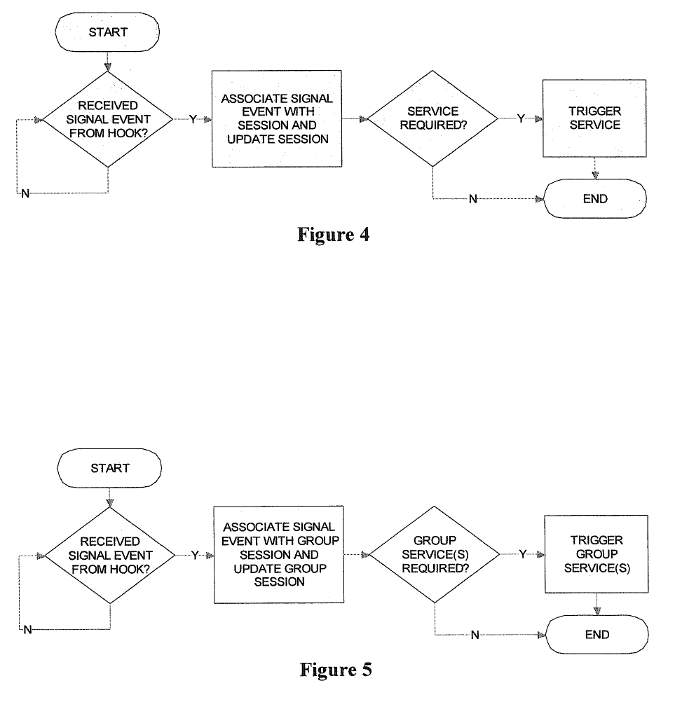

One aspect of the present invention, illustrated in FIG. 4, is a process of providing a combinational service to an individual wherein the system maintains a state, i.e., a session. In this case, when the hook(s) detect a signal event, the system associates the event with a session and updates the session state. If the session state requires a service, the appropriate service is triggered; otherwise, no service is provided. In the first case, the signal event is used solely to update the session. In second case, the session is updated, and then the service is triggered.

### Session Combinational Service for Group

In this case, illustrated in FIG. 5, the combinational service is provided to a group. When the system receives a signal event for a hook, it associates the event with a session and updates the session, and then it triggers a group service if required by the session state.

### Extensions

In any of the above-described processes, the hooks may be placed at one or more of the different points in the PSTN network with any SP or STP SS7/PSTN node or nodes. The non-intrusive hooks can be placed at different points in the PSTN network along with any SP or STP SS7/PSTN nodes. The hooks may also be placed into other networks such as GSM, CDMA or SMS networks. For example, they may be placed at one or more of the following nodes: MSC, GMSC, SGSN, GGSN, HLR, SMSC, MMSC, BSC, Class 5 switch or Class 4 switch.

In any of the above-described processes, the hooks may be placed in any of the SS7/PSTN variants that are currently in use or may be used in the future. These include, but are not limited to, ANSI (US) network, ITU-T (Europe/Asia) network, Japanese network, and Korean network.

### Implementation

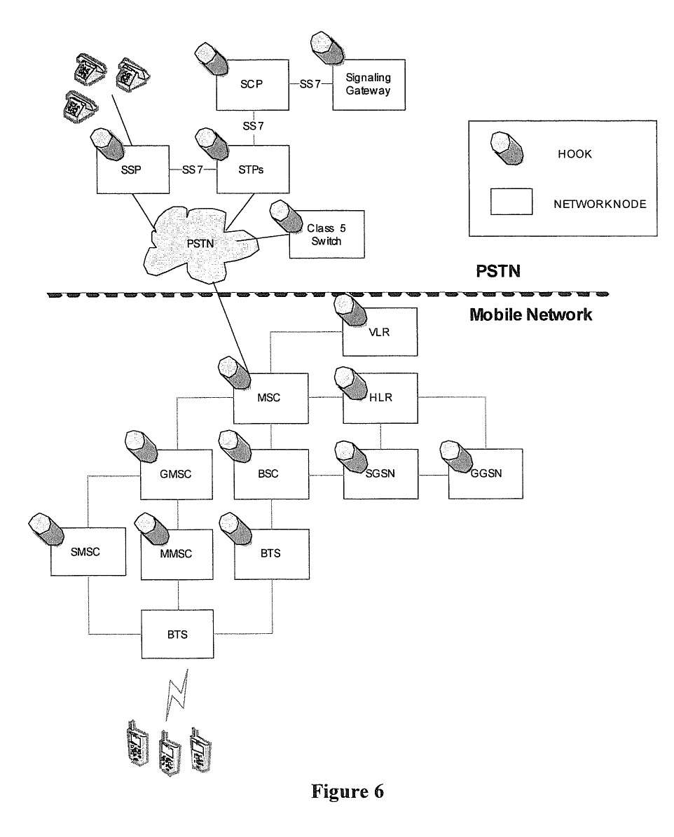

The network diagram shown in FIG. 6 illustrates a PSTN and Mobile network with a set of non-intrusive hooks. A non-intrusive hook is physically connected to the network and is able to read the binary data flowing on the network. It is able to read the data without disturbing the data flow. Furthermore, the hook is able to decode the data stream and detect signal events. The hardware is controlled by a control program that is capable of being programmed to perform combinational services based on a particular signal event or set of signal events maintained over a session.

In general, the combinational services enabled by the present invention are diverse. The services may fall into any one of the following groups: Analytical, Advertising, User Profiling, Personal Assistant and Reporting at different levels. The service channel(s) and the hook channel(s) may be the different. The present invention has a distinct feature in that it will not affect the current Operational Support Systems (OSS) or Business Support Systems.

The combinational service(s) can be targeted for multiple users. Specifically, they may be targeted to any of the following: End Users/ Phone Customers, Family Groups, Enterprise/Physical Groups, Virtual Groups, Operators and Security Agencies.

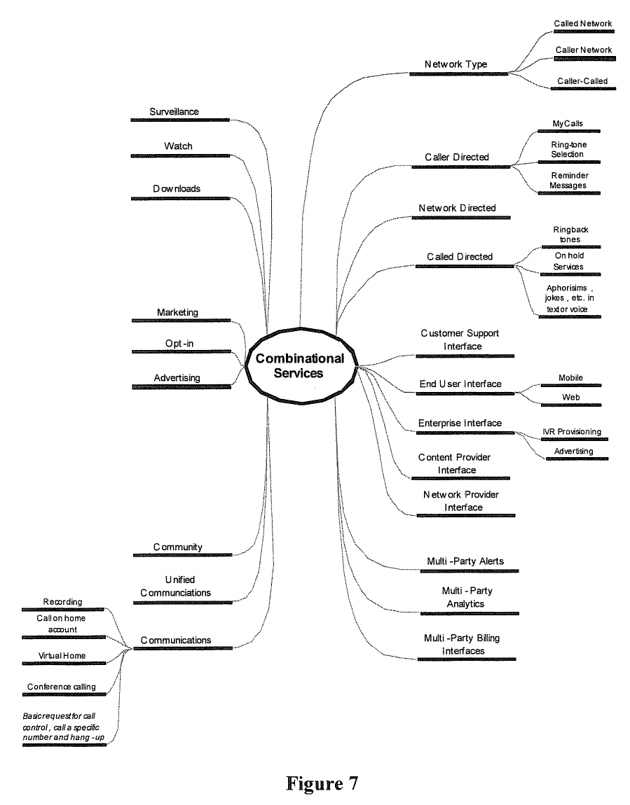

FIG. 7 presents a summary of various embodiments of the invention. The following is a brief description of possible combinational services that pertain to the present invention.

### Hooks on Various Networks

The non-intrusive hook can be placed on various networks. The system is able to distinguish between the caller network and the called network. Various services are supported depending on whether the hook is on the called network, caller network, or both.

### Called Directed

Services may be triggered based on the number called. For example, a specific ringback tone may be triggered when a certain number is called. A ringback tone is the sound or music heard by the caller before the called party picks up the phone.

Other called directed services include on-hold services and called directed message services. An on-hold service is triggered when the hook detects that the caller is placed on-hold. The on-hold service could play news, interactive trivia or play music. Various messages could be triggered based on the called number. The service could provide aphorisms, jokes, quotes or other information through various communication channels including a text message or voice.

### Caller Directed

In one embodiment, the present invention provides caller directed services. For example, consider a non-intrusive hook that triggers a call monitoring service that records and reports the number and types of calls a user makes over a segment of time. Other caller directed services include ring-tone selection and reminder messages.

### Caller Called

A service may be triggered based on the combination of the called number and the caller number. For example, the called party may configure the service to play different ringback tones depending on how the called party configures the system to react to the caller's number.

### Network Directed

The services may be network directed. For example, different service may be provided depending on whether the caller is using a mobile phone with advanced features versus a standard PSTN phone.

### Communications

The system may be used for various types of personal and group communication. It may be used to record personal messages, to provide call forwarding services, conference calling or call control. For example, a person could call a specific number and hang-up in order to set various services. This notification preference could include a may include call-forwarding preferences or set a system to notify the user when certain events happen.

### Virtual Home

The present invention may be used to provide virtual home and call-on-home account services. Home refers to user's home network. A virtual home service is able to sniff SS7 signals when the user moves outside of his/her home network, then configure this outside network with preferences he/she set on his/her home network, thus, creating a virtual home network.

A “call-on-home” service enables a person to make an inexpensive call in situations where it is expensive to make an outgoing call but inexpensive to receive a call. A call-on-home service works as follows: a user calls a specific number; the non-intrusive hook detects the signal, caller's number and called number; the system initiates a call to the called number, and then patches the caller in.

### Unified Communications/Messaging

The present invention is able to provide unified communication services that integrate several forms of communication, i.e. voice, fax, SMS, email, etc. Consider a scenario in which Bob leaves Marsha a voice mail on her home phone. One embodiment of the present invention is able to intercept a voice message using a non-intrusive hook, then trigger a unified communications service. One possible unified service is a message translation/forwarding service that transforms the voice mail into a text message and sends it to Marsha's cell phone as a SMS message.

### Downloads

The present invention allows users to download information based on the phone number called or other information detected by the hooks. For example, a hook may trigger a service that downloads wallpapers, ringtones, or games to a phone.

### Community

The system may be used to provide community services.

### User Profiling

Another type of combinational service is a user profiling service. The service is able to generate a profile of the user call patterns including duration, numbers, and date and time of calls. The system periodically sends a report message over a different communication channel, for example an email. In this case, a session is used to monitor the behavior over time. The report could be sent to an individual or a group.

### Watching/Monitoring

The invention could be used as a monitoring system. For example, one embodiment would allow parents to monitor their child's phone usage. In particular, the system could send a parent a SMS message if the child places an expensive call, such as a call to a (900) number or long distance call. Similarly, the service could watch if a specific number is called. The system also has the ability to monitor the child's phone usage over time, using a session. For example, the system could be configured to notify the parents if the user makes 10 calls or uses more that 60 minutes of cell phone time in a day.

### Surveillance

The invention could be used to provide surveillance to security agencies. In one embodiment, a surveillance service would be triggered by one or more hooks on one or more communication channels. The surveillance service could simply record all communication channels or process the information being sent on the communication channels. The hook could trigger an alert when a keyword was spoken or could create various calls logs.

### Interfaces

The present invention could be used as an interface for various groups or organizations. It could be used as a customer support interface, end user interface, enterprise interface, content provider interface or network provider interface. Examples are given below.

As a customer support interface, the system could be used to track interactions with customers, send them text or voice information, or provide a means to ensure quality control.

As an end user interface, it could provide value added services to their mobile phones or it could be used as a mobile web interface.

As an enterprise interface it could provide Interactive Voice Response (IVR) system or be used for advertising. User targeted advertising could be provided by tracking a user's phone usage.

Content providers could use the present invention to provide various content, including wallpapers, mobile web content and ringtones.

As a network provider interface, it could be used to monitor traffic and provide network specific messages.

### Multi-Party Services

The system could be used to provide various multi-party services. These include multi-party alerts, a multi-party billing interface and multi-party analytics. For example, if a person is planning to join a conference call with ten other people, the system could notify him/her when at least eight people have dialed into the conference call. The system could also track and analyze the calls made by all members of a family or enterprise and compute the total phone usage. This could be tied to a billing service to bill the family or enterprise based on usage. The services may also be applied to virtual groups.

### Marketing

The present invention may be used for a variety of marketing services including advertising and opt-in services.

### Advertising

One type of combinational service is an advertising service provided to a phone customer. Consider a scenario when a phone customer calls a movie directory service in order to find show times of movies in caller's area. The hook determines the caller's cellular phone number, then sends the caller a message over a different channel. For instance, the system may send a SMS or MMS message advertising a particular movie. The advertisement may be specialized depending on the user's selections. For example, the message could contain an advertisement for similar movies to the ones the user selected or it could be an advertisement for discounts to a particular theater in the user's area.

### Opt-In

The present invention could be used to provide an opt-in service. An opt-in service allows a user to subscribe to a service such as a messaging subscription. Such a service could provide advertisements, news, etc. through one or more communication channels. The present invention would allow a user to opt-in by detecting the numbers a user calls.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A method of providing combinational services comprising:
sniffing traffic on a network;
detecting a signal event;
determining a service corresponding to the detected signal event;
providing the service.

2. The method of claim 1 wherein the network comprises a SS7/PSTN network.

3. The method of claim 1 wherein determining a service corresponding to the detected signal event comprises looking up an entry in a database.

4. The method of claim 1 wherein the service is provided on a communication channel different than the channel carrying the detected signal event.

5. The method of claim 1 wherein the service is provided to an individual.

6. The method of claim 1 wherein the service is provided to a group.

7. A method of providing combinational services comprising:
sniffing traffic on a network;
detecting a signal event;
associating the detected signal event with a session;
updating the session state;
determining if a service is required by the session state;
providing the service, if required.

8. The method of claim 17 wherein the network comprises a SS7/PSTN network.

9. The method of claim 17 wherein the service is provided on a communication channel different than the channel carrying the detected signal event.

10. The method of claim 17 wherein the service is provided to an individual.

11. The method of claim 17 wherein the service is provided to a group.
